(19) United States
(12) Patent Application Publication
(10) Pub. No.: US 2023/0031460 A1
(43) Pub. Date: Feb. 2, 2023

(54) POWER PATH SWITCHING APPARATUS FOR VEHICLE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Tomohiro TANIGUCHI, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 17/791,743

(22) PCT Filed: Jan. 7, 2021
(86) PCT No.: PCT/JP2021/000266

§ 371 Date: Jul. 8, 2022

(30) Foreign Application Priority Data
Jan. 9, 2020 (JP) 2020-002050

(51) Int. Cl. H01M 50/298; H01M 10/42; H01M 50/249; H02J 1/08; B60W 10/26

(52) U.S. Cl. CPC H01M 50/298; H01M 10/425; H01M 50/249; H02J 1/084; B60W 10/26; H02J 2310/40

(57) ABSTRACT

A power path switching apparatus includes a first terminal unit and a second terminal unit provided in a battery pack that includes a plurality of battery modules, and a switching unit that is provided in the battery pack, and switches a path for supplying power from the battery modules, the first terminal unit and the second terminal unit being disposed away from each other at different positions in the battery pack, and the switching unit switches between a first state in which one of the first terminal unit and the second terminal unit serves as an output path of power, and a second state in which one of the first terminal unit and the second terminal unit different from the first state serves as an output path of power.

### TECHNICAL FIELD

The present disclosure relates to a power path switching apparatus for a vehicle.

### BACKGROUND ART

An in-vehicle battery pack disclosed in Patent Document 1 has a configuration in which a plurality of battery modules are housed in a case. This type of battery pack includes a terminal unit for supplying power to the outside, and this terminal unit is provided at a predetermined position.

### CITATION LIST

### Patent Documents

Patent Document 1: JP 2010-15931A

Patent Document 2: JP 2012-176634A

### SUMMARY OF INVENTION

### Technical Problem

When a vehicle battery pack is mounted in a vehicle in which targets for supplying power from the battery pack are disposed mainly on the front side (for example, a front-wheel drive vehicle in which a drive motor is disposed on the front side of the vehicle), an output terminal of the vehicle battery pack is desirably disposed on the front side. Conversely, when a vehicle battery pack is mounted in a vehicle in which targets for supplying power from the battery pack are disposed mainly on the rear side (for example, a rear wheel drive vehicle in which a drive motor is disposed on the rear side of the vehicle), an output terminal thereof is desirably disposed on the rear side. However, a manufacturing method in which a dedicated battery pack is prepared in accordance with a vehicle to which the battery pack is to be applied is disadvantageous in terms of using common components.

In view of this, an object of the present disclosure is to provide a technique for easily applying a battery pack that is common to different types of vehicles.

### Solution to Problem

A power path switching apparatus for a vehicle according to the present disclosure includes:

a plurality of terminal units configured to be provided in a battery pack that includes a plurality of battery modules, and

a switching unit configured to be provided in the battery pack, and to switch a path for supplying power from the battery modules,

the plurality of terminal units being disposed away from each other at different positions in the battery pack, and

the switching unit changes a combination of an in-use terminal unit that is used as an output path of the power and a non-use terminal unit that is not used as an output path of the power, among the plurality of terminal units, between a first state and a second state.

### Advantageous Effects of Invention

A power path switching apparatus according to the present disclosure makes it easy to apply a common battery pack to different types of vehicles.

### BRIEF DESCRIPTION OF DRAWINGS

FIG. 1 is a schematic diagram conceptually showing a state where a battery pack that includes a power path switching apparatus according to a first embodiment is mounted in a vehicle.

FIG. 2 is a circuit diagram schematically showing a configuration of the battery pack that includes the power path switching apparatus according to the first embodiment.

FIG. 3 is a circuit diagram showing a state where, in the battery pack that includes the power path switching apparatus according to the first embodiment, a first terminal unit serves as an in-use terminal unit.

FIG. 4 is a circuit diagram showing a state where, in the battery pack that includes the power path switching apparatus according to the first embodiment, a second terminal unit serves as an in-use terminal unit.

FIG. 5 is a circuit diagram showing a state where, in the battery pack that includes the power path switching apparatus according to the first embodiment, the first terminal unit and the second terminal unit serve as in-use terminal units.

FIG. 6 is a circuit diagram showing a state where, in a battery pack that includes a power path switching apparatus according to a second embodiment, a first terminal unit serves as an in-use terminal unit.

FIG. 7 is a circuit diagram showing a state where, in the battery pack that includes the power path switching apparatus according to the second embodiment, a second terminal unit serves as an in-use terminal unit.

FIG. 8 is a circuit diagram showing a state where, in the battery pack that includes the power path switching apparatus according to the second embodiment, the first terminal unit and the second terminal unit serve as in-use terminal units.

FIG. 9 is a circuit diagram showing a state where, in a battery pack that includes a power path switching apparatus according to a third embodiment, a first terminal unit serves as an in-use terminal unit.

FIG. 10 is a circuit diagram showing a state where, in the battery pack that includes the power path switching apparatus according to the third embodiment, a second terminal unit serves as an in-use terminal unit.

FIG. 11 is a circuit diagram showing a state where, in the battery pack that includes the power path switching apparatus according to the third embodiment, the first terminal unit and the second terminal unit serve as in-use terminal units.

### EMBODIMENTS OF INVENTION

Embodiments of the present disclosure will be listed and described below. Note that the features of (1) to (8) to be described below may be combined in any manner in an aspect in which no contradiction arises.

(1) A power path switching apparatus for a vehicle according to the present disclosure includes: a plurality of terminal units configured to be provided in a battery pack that includes a plurality of battery modules, and a switching unit configured to be provided in the battery pack, and to switch a path for supplying power from the battery modules, the plurality of terminal units being disposed away from each other at different positions in the battery pack, and the switching unit changes a combination of an in-use terminal unit that is used as an output path of the power and a non-use terminal unit that is not used as an output path of the power, among the plurality of terminal units, between a first state and a second state.

In the power path switching apparatus in the above (1), the plurality of terminal units are disposed away from each other at different positions, and the switching unit can switch the state of an output path extending through the plurality of terminal units between the first state and the second state. The combination of the in-use terminal unit and the non-use terminal unit from among the plurality of terminal units can be changed between the first state and the second state. Thus, the above power path switching apparatus makes it possible to apply a common battery pack when mounting it in a vehicle suitable for the output path in the first state and when mounting it in a vehicle suitable for the output path in the second state.

(2) In the power path switching apparatus for a vehicle according to (1), the plurality of terminal units include at least a first terminal unit and a second terminal unit, the first terminal unit is a terminal disposed on one side in a predetermined direction of the battery pack, the second terminal unit is a terminal disposed on the other side in the predetermined direction of the battery pack relative to the first terminal unit, and the switching unit switches between a one-side output state in which the first terminal unit serves as the in-use terminal unit and the second terminal unit serves as the non-use terminal unit and an other-side output state in which the second terminal unit serves as the in-use terminal unit and the first terminal unit serves as the non-use terminal unit.

The plurality of terminal units of the power path switching apparatus according to the above (2) are disposed away from each other at different positions, and thus, as a result of the switching unit switching the state of the plurality of terminal unit between the one-side output state and the other-side output state, it is possible to change the position from which power is output to the outside.

(3) In the power path switching apparatus for a vehicle according to (2), the switching unit switches between the one-side output state, the other-side output state, and a both-sides output state in which both the first terminal unit and the second terminal unit serve as the in-use terminal unit.

The power path switching apparatus according to the above (3) switches of the state of the plurality of terminal units to the both-sides output state in addition to the one-side output state and the other-side output state, thereby easily supporting the specifications of a vehicle to which the battery pack is mounted, in a flexible manner.

(4) In the power path switching apparatus for a vehicle according to (1), the plurality of terminal units include a first terminal unit and a second terminal unit, the first terminal unit is a terminal disposed on one side in a predetermined direction relative to the second terminal unit, in a vehicle in which the battery pack is to be mounted, and the switching unit switches between an either-side output state in which one of the first terminal unit and the second terminal unit serves as the in-use terminal unit and the other thereof serves as the non-use terminal unit and a both-sides output state in which both the first terminal unit and the second terminal unit serve as the in-use terminal unit.

In the power path switching apparatus according to the above (4), when a variation suitable for the either-side output state arises in a vehicle suitable for the both-sides output state, it is easy to support the specifications of the vehicle in a flexible manner.

(5) In the power path switching apparatus for a vehicle according to (3) or (4), in the both-sides output state, the switching unit configures a path for outputting power from a portion of the plurality of battery modules via the first terminal unit, and configures a path for outputting power from another portion different from the portion of the plurality of battery modules via the second terminal unit.

In the power path switching apparatus according to the above (5), as a result of a different battery module being connected to each terminal unit, it is easy to avoid a state where power cannot be output from both the first terminal unit and the second terminal unit.

(6) In the power path switching apparatus for a vehicle according to (5), when one of the first terminal unit and the second terminal unit serves as the in-use terminal unit and the other thereof serves as the non-use terminal unit, the switching unit switches at least a portion of the plurality of battery modules to a parallel connection state, and, in the both-sides output state, the switching unit switches the portion and the other portion individually to an in-series connection state.

In the power path switching apparatus according to the above (6), connection of the plurality of battery modules is switched to a parallel connection state and an in-series connection state, in accordance with the use state of the first terminal unit and the second terminal unit. Accordingly, the power path switching apparatus can effectively use the plurality of battery modules, when power is output from one of the terminal units and when power is output from both the terminal units.

(7) In the power path switching apparatus for a vehicle according to any one of (2) to (5), the predetermined direction is a front-rear direction of the vehicle.

In the power path switching apparatus according to the above (7), when a load to be supplied with power is present on the front side and the rear side of the vehicle, a terminal unit that is closer to this load is connected to the battery modules, and thereby it is possible to shorten the wiring that connects the load and the terminal unit in the vehicle.

(8) The power path switching apparatus for a vehicle according to any one of (1) to (7) further includes a connector unit configured to be attachable/detachable to/from the terminal units, and the connector unit is attached to the non-use terminal unit, and establishes electrical continuity between a plurality of predetermined terminals in the non-use terminal unit while covering the non-use terminal unit.

The power path switching apparatus according to the above (8) can simplify the configuration of the switching unit.

(9) In the power path switching apparatus for a vehicle according to (8), the connector unit includes a cover portion that covers the non-use terminal unit in a watertight manner.

The connector unit according to the above (9) can prevent water from infiltrating into the battery pack.

### DETAILED EMBODIMENTS OF PRESENT DISCLOSURE

### First Embodiment

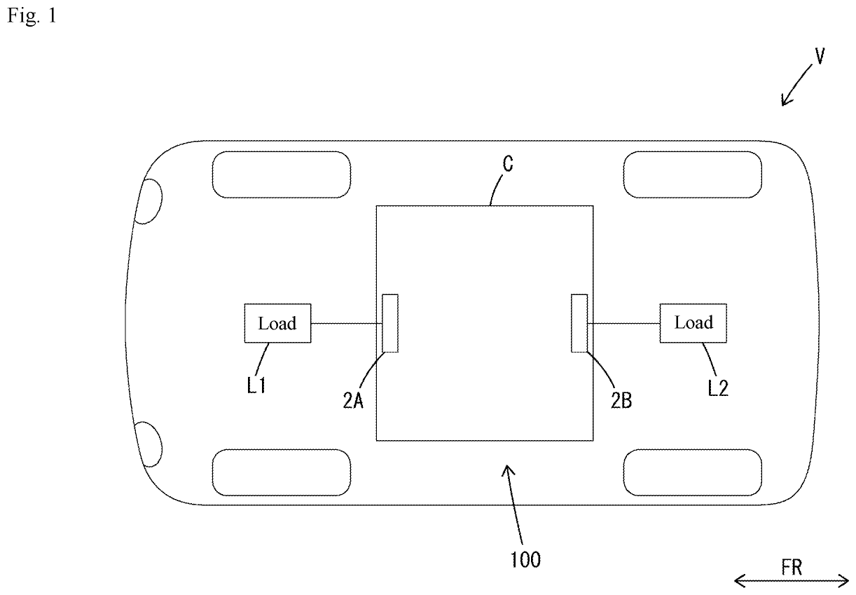

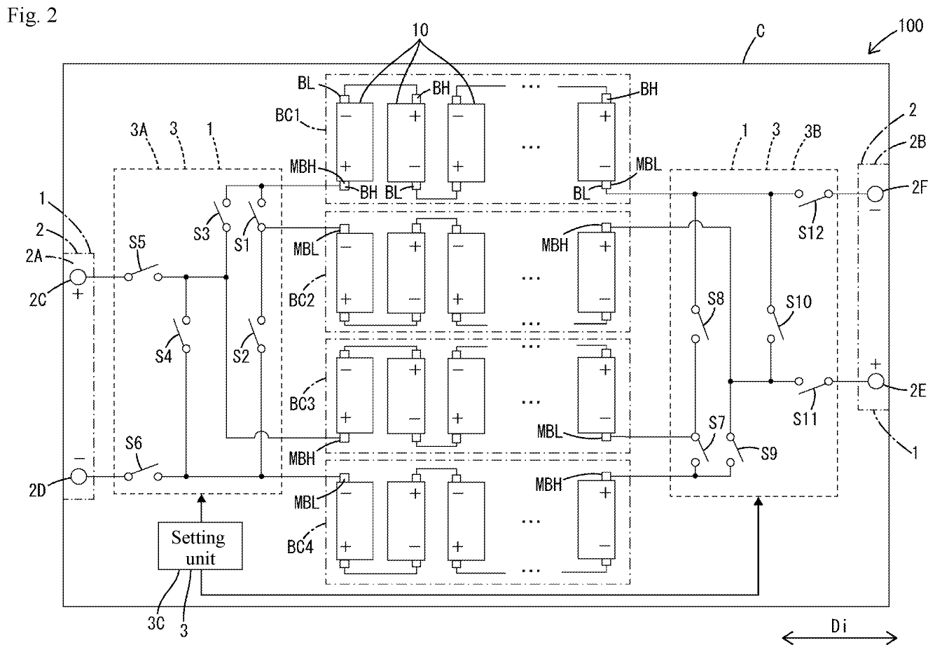

FIG. 1 illustrates a state where a battery pack 100 in which a power path switching apparatus 1 according to a first embodiment is provided is mounted in a vehicle V. The vehicle V is an electric automobile, a hybrid automobile, or the like. The battery pack 100 is used as a power source for operating loads L1 and L2 (for example, motors that drive the wheels) of the vehicle V in which the battery pack 100 is mounted. As shown in FIG. 2, the battery pack 100 includes a plurality of battery modules 10, terminal units 2, and a switching unit 3, and the like. Each of the battery modules 10 includes a plurality of battery parts configured as unit batteries, and is a module obtained by integrally combining the battery parts. Each battery module 10 is formed to be long in one direction.

On one side in the direction in which each battery module 10 is formed to be long, a high-potential side electrode BH connected to a highest-potential electrode of the plurality of unit batteries connected in series is provided. On the other side in the direction in which the battery module 10 is formed to be long, a low-potential side electrode BL connected to a lowest-potential negative electrode of the plurality of unit batteries connected in series is provided.

### Configuration of Battery Pack

The battery pack 100 includes the plurality of battery modules 10, and a case C that houses the plurality of battery modules 10. The battery pack 100 is a battery unit that includes the plurality of battery modules 10, and is configured to able to output a predetermined output voltage. The battery pack 100 is configured as an integral battery in a form in which the plurality of battery modules 10 are housed in the case C. A plurality of battery modules 10 are aligned in one direction such that orientations in which the high-potential side electrodes BH and the low-potential side electrodes BL are disposed alternate, and constitute one module row. The battery pack 100 includes four module rows BC1, BC2, BC3, and BC4. In each of the module rows BC1, BC2, BC3, and BC4, a plurality of battery modules 10 are electrically connected in series to each other. The module rows BC1, BC2, BC3, and BC4 are disposed such that a highest-potential electrode MBH that is a high-potential side electrode BH having the highest potential in each row and a lowest-potential electrode MBL that is a low-potential side electrode BL having the lowest potential in the row alternate. In the module rows BC1, BC2, BC3, and BC4, the numbers of battery modules 10 are the same.

### Configuration of Terminal Units

The terminal units 2 include a first terminal unit 2A and a second terminal unit 2B. That is to say, the power path switching apparatus 1 includes a plurality of terminal units 2. The first terminal unit 2A and the second terminal unit 2B are disposed in the case C, on one side and the other side in a direction in which the highest-potential electrode MBH and the lowest-potential electrode MBL are aligned in each of the module rows BC1, BC2, BC3, and BC4. The first terminal unit 2A and the second terminal unit 2B are disposed away from each other at different positions in the battery pack 100. Specifically, the first terminal unit 2A is disposed at an end portion on one side in a predetermined direction Di of the battery pack 100 or at a position close to the end portion on the one side. The second terminal unit 2B is disposed at an end portion on the other side in the predetermined direction Di of the battery pack 100 or at a position close to the end portion on the other side. The predetermined direction Di is the front-rear direction of the battery pack 100 (see FIG. 2). The front-rear direction of the battery pack 100 is a direction that lies along a front-rear direction FR of the vehicle V when the battery pack 100 is mounted in the vehicle V, for example (FIGS. 1 and 2). In the vehicle V in which the battery pack 100 is mounted, the first terminal unit 2A is disposed on one side in the predetermined direction Di relative to the second terminal unit 2B (see FIG. 1). The first terminal unit 2A includes a first positive terminal 2C and a first negative terminal 2D. The second terminal unit 2B includes a second positive terminal 2E and a second negative terminal 2F.

### Configuration of Switching Unit

The switching unit 3 is provided in the battery pack 100, and has a function of switching a path for supplying power from the battery modules 10. The switching unit 3 includes a first switching circuit 3A, a second switching circuit 3B, and a setting unit 3C. The first switching circuit 3A and the second switching circuit 3B are respectively disposed on one side and the other side in a direction in which the highest-potential electrode MBH and the lowest-potential electrode MBL are positioned in each of the module rows BC1, BC2, BC3, and BC4.

The first switching circuit 3A includes a first switch S1, a second switch S2, a third switch S3, a fourth switch S4, a fifth switch S5, and a sixth switch S6. The first switch S1, the second switch S2, the third switch S3, the fourth switch S4, the fifth switch S5, and the sixth switch S6 are each constituted by, for example, a relay switch or a semiconductor switch such as MOSFET. The first switch S1 is electrically connected to the highest-potential electrode MBH of the module row BC1 and the lowest-potential electrode MBL of the module row BC2. The second switch S2 is electrically connected to the lowest-potential electrodes MBL of the module rows BC2 and BC4. The third switch S3 is electrically connected to the highest-potential electrodes MBH of the module rows BC1 and BC3. The fourth switch S4 is electrically connected to the highest-potential electrode MBH of the module row BC3 and the lowest-potential electrode MBL of the module row BC4. The fifth switch S5 is electrically connected to the highest-potential electrode MBH of the module row BC3 and the first positive terminal 2C of the first terminal unit 2A. The sixth switch S6 is electrically connected to the lowest-potential electrode MBL of the module row BC4 and the first negative terminal 2D of the first terminal unit 2A.

In the present disclosure, being “electrically connected” desirably refers to a configuration in which two connection targets are connected in a state of being in electrical continuity with each other such that the potentials thereof are the same (a state where a current can flow). Note that there is no limitation to this configuration. Being “electrically connected” may also refer to a configuration in which two connection targets are connected in a state of being able to be in electrical continuity with an electric component disposed therebetween, for example.

The second switching circuit 3B includes a seventh switch S7, an eighth switch S8, a ninth switch S9, a tenth switch S10, an eleventh switch S11, and a twelfth switch S12. The seventh switch S7, the eighth switch S8, the ninth switch S9, the tenth switch S10, the eleventh switch S11, and the twelfth switch S12 are each constituted by, for example, a relay switch or a semiconductor switch such as MOSFET. The seventh switch S7 is electrically connected to the highest-potential electrode MBH of the module row BC4 and the lowest-potential electrode MBL of the module row BC3. The eighth switch S8 is electrically connected to the lowest-potential electrodes MBL in the module rows BC1 and BC3. The ninth switch S9 is electrically connected to the highest-potential electrodes MBH in the module rows BC2 and BC4. The tenth switch S10 is electrically connected to the lowest-potential electrode MBL of the module row BC1 and the highest-potential electrode MBH of the module row BC2. The eleventh switch S11 is electrically connected to the highest-potential electrode MBH of the module row BC2 and the second positive terminal 2E of the second terminal unit 2B. The twelfth switch S12 is electrically connected to the lowest-potential electrode MBL of the module row BC1 and the second negative terminal 2F of the second terminal unit 2B.

The setting unit 3C is constituted by an information processing apparatus such as a microcomputer, and has a function of switching the states of the switches in the first switching circuit 3A and the second switching circuit 3B between an on-state and an off-state, and setting the states of the switches. The battery pack 100 configured in this manner is mounted in the vehicle V, for example, with the first terminal unit 2A disposed close to the front of the vehicle V and the second terminal unit 2B disposed close to the rear of the vehicle V (see FIG. 1).

### Operations of Battery Pack 100

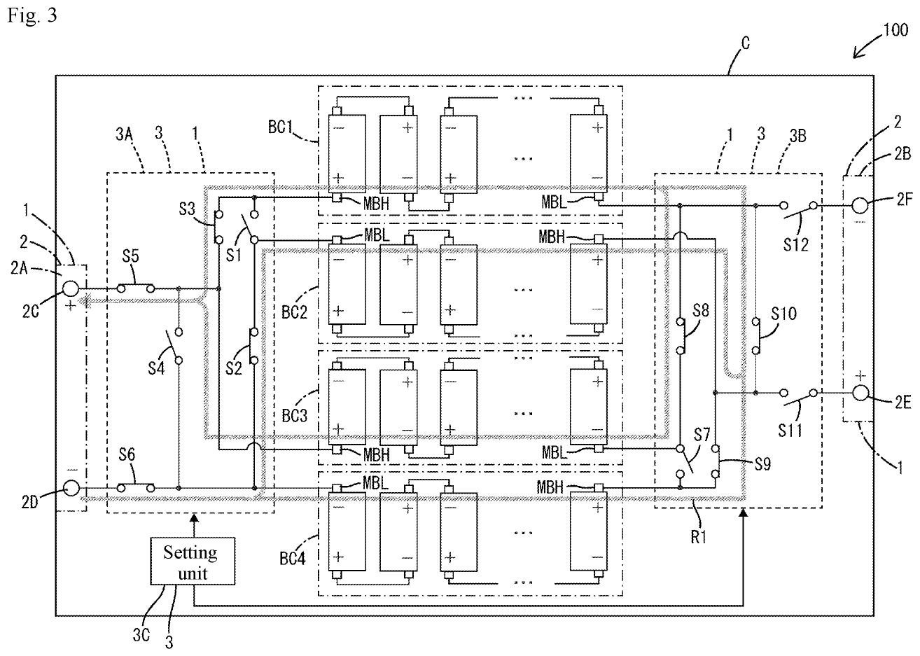

A case will be described in which the switching unit 3 switches an output path of power to the first terminal unit 2A. An in-use terminal unit refers to a terminal unit 2 that is used as a power path from among the first terminal unit 2A and the second terminal unit 2B (the plurality of terminal units). A non-use terminal unit refers to a terminal unit 2 that is not used as a power path from among the first terminal unit 2A and the second terminal unit 2B (the plurality of terminal units). In the example of the first embodiment, the in-use terminal unit is a terminal unit 2 through which a current flows, and the non-use terminal unit is a terminal unit 2 through which a current does not flow. The setting unit 3C switches the states of the switches and sets in the first switching circuit 3A and the second switching circuit 3B as shown in FIG. 3. Specifically, the setting unit 3C sets the second switch S2, the third switch S3, the fifth switch S5, and the sixth switch S6 in the first switching circuit 3A to an on-state, and sets the first switch S1 the fourth switch S4 to an off-state. In addition to this, the setting unit 3C sets the eighth switch S8, the ninth switch S9, and the tenth switch S10 in the second switching circuit 3B to an on-state, and sets the seventh switch S7, the eleventh switch S11, and the twelfth switch S12 to an off-state.

At this time, the module rows BC1 and BC3 are connected in parallel, and the module rows BC2 and BC4 are connected in parallel. Accordingly, when the first terminal unit 2A serves as an in-use terminal unit and the other terminal unit serves as a non-use terminal unit, the switching unit 3 connects the plurality of battery modules 10 in parallel. In this manner, the power path switching apparatus 1 realizes a configuration in which a current flows through the path indicated by the arrow R1. At this time, the first terminal unit 2A is an in-use terminal unit that is used as an output path of power, and the second terminal unit 2B is a non-use terminal unit is not used as an output path of power. At this time, the state is the one-side output state in which the first terminal unit 2A serves as an in-use terminal unit and the second terminal unit 2B serves as a non-use terminal unit.

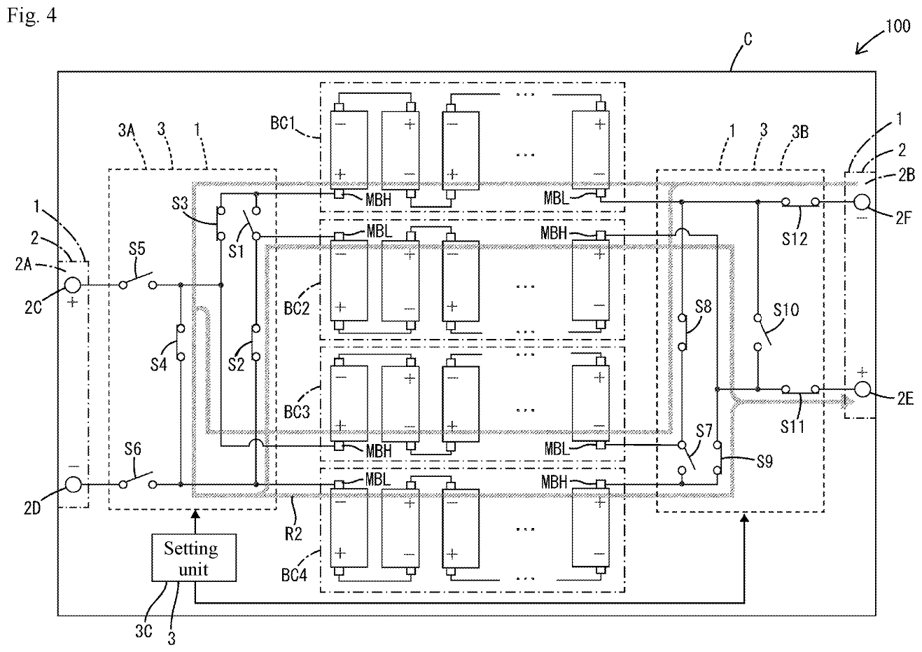

A case will be described in which the switching unit 3 switches an output path of power to the second terminal unit 2B. In this case, the setting unit 3C switches and sets the states of the switches in the first switching circuit 3A and the second switching circuit 3B as shown in FIG. 4. Specifically, the setting unit 3C sets the second switch S2, the third switch S3, and the fourth switch S4 in the first switching circuit 3A to an on-state, and sets the first switch S1, the fifth switch S5, and the sixth switch S6 to an off-state. In addition to this, the setting unit 3C sets the eighth switch S8, the ninth switch S9, the eleventh switch S11, and the twelfth switch S12 in the second switching circuit 3B to an on-state, and sets the seventh switch S7 and the tenth switch S10 to an off-state.

At this time, the module rows BC1 and BC3 are connected in parallel, and the module rows BC2 and BC4 are connected in parallel. That is to say, when the second terminal unit 2B serves as an in-use terminal unit and the other terminal unit serves as a non-use terminal unit, the switching unit 3 connects the plurality of battery modules 10 in parallel. In this manner, the power path switching apparatus 1 realizes a configuration in which a current flows through the path indicated by the arrow R2. At this time, the second terminal unit 2B is an in-use terminal unit that is used as an output path of power, and the first terminal unit 2A is a non-use terminal unit that is not used as an output path of power. The switching unit 3 switches between the one-side output state in which the first terminal unit 2A serves as an in-use terminal unit and the second terminal unit 2B serves as a non-use terminal unit, and an other-side output state in which the second terminal unit 2B serves as an in-use terminal unit and the first terminal unit 2A serves as a non-use terminal unit. At this time, the state is the other-side output state in which the second terminal unit 2B serves as an in-use terminal unit and the first terminal unit 2A serves as a non-use terminal unit.

In this case, the one-side output state corresponds to a first state, and the other-side output state corresponds to a second state. In the one-side output state (first state), the first terminal unit 2A serves as an in-use terminal unit and the second terminal unit 2B (the other terminal unit) serves as a non-use terminal unit. In the other-side output state (second state), the second terminal unit 2B serves as an in-use terminal unit and the first terminal unit 2A (the other terminal unit) serves as a non-use terminal unit. That is to say, the switching unit 3 changes the combination of an in-use terminal unit that is used as an output path of power and a non-use terminal unit that is not used as an output path of power, among the terminal units 2, between the one-side output state (first state) and the other-side output state (second state).

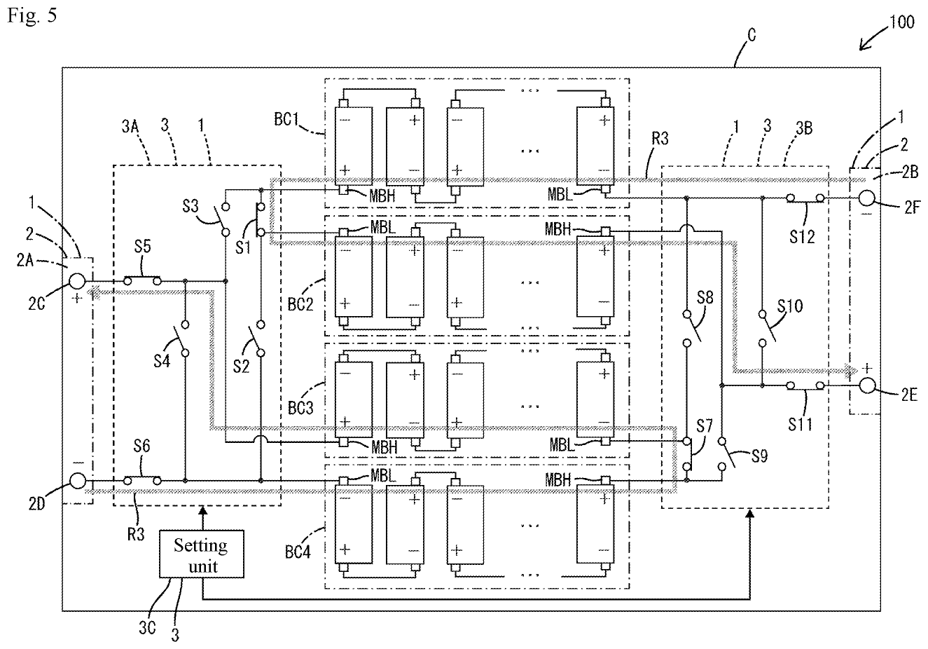

A case will be described in which the switching unit 3 switches to a both-sides output state in which both the first terminal unit 2A and the second terminal unit 2B serve as in-use terminal units. In this case, the setting unit 3C switches and sets the states of the switches in the first switching circuit 3A and the second switching circuit 3B as shown in FIG. 5. Specifically, the setting unit 3C sets the first switch S1, the fifth switch S5, and the sixth switch S6 in the first switching circuit 3A to an on-state, and sets the second switch S2, the third switch S3, and the fourth switch S4 to an off-state. In addition to this, the setting unit 3C sets the seventh switch S7, the eleventh switch S11, and the twelfth switch S12 in the second switching circuit 3B to an on-state, and sets the eighth switch S8, the ninth switch S9, and the tenth switch S10 to an off-state.

At this time, the module rows BC1 and BC2 are connected in series, and the module rows BC3 and BC4 are connected in series. That is to say, in the both-sides output state, the switching unit 3 connects the plurality of battery modules 10 in-series. In this manner, the power path switching apparatus 1 realizes a configuration in which a current flows through the path indicated by the arrow R3. At this time, the number of battery modules 10 in the path indicated by the arrow R3 on the first terminal unit 2A side and the number of battery modules 10 on the path indicated by the arrow R3 on the second terminal unit 2B side are the same. In the both-sides output state, the switching unit 3 configures a path for outputting power from a portion of the plurality of battery modules 10, via the first terminal unit 2A, and configures a path for outputting power from another portion different from the portion of the plurality of battery modules 10, via the second terminal unit 2B.

In this manner, the switching unit 3 can switch between the one-side output state, the other-side output state, and the both-sides output state. The switching unit 3 can also switch between an either-side output state in which one of the first terminal unit 2A and the second terminal unit 2B serves as an in-use terminal unit and the other thereof serves as a non-use terminal unit and the both-sides output state in which both the first terminal unit 2A and the second terminal unit 2B serve as in-use terminal units. In this case, the either-side output state corresponds to a first state, and the both-sides output state corresponds to a second state. In the either-side output state (first state), one of the first terminal unit 2A and the second terminal unit 2B serves as an in-use terminal unit, and the other thereof serves as a non-use terminal unit. In the both-sides output state (second state), there is no terminal unit 2 that corresponds to a non-use terminal unit. That is to say, the switching unit 3 changes the combination of an in-use terminal unit that is used as an output path of power and a non-use terminal unit that is not used as an output path of power, among the terminal units 2, between the either-side output state (first state) and the both-sides output state (second state).

Next, the effects of the configuration according to the present disclosure will be illustrated.

The power path switching apparatus 1 according to the present disclosure includes the first terminal unit 2A and the second terminal unit 2B that are provided in the battery pack 100 that includes the plurality of battery modules 10, and the switching unit 3 that is provided in the battery pack 100, and switches a path for supplying power from the battery modules 10. The first terminal unit 2A and the second terminal unit 2B are disposed away from each other at different positions in the battery pack 100. The switching unit 3 changes the combination of an in-use terminal unit that is used as an output path of power and a non-use terminal unit that is not used as an output path of power, among the terminal units 2, between the first state and the second state.

In the power path switching apparatus 1, the first terminal unit 2A and the second terminal unit 2B are disposed away from each other at different positions, and the switching unit 3 can switch the state of an output path extending through the first terminal unit 2A and the second terminal unit 2B between the first state and the second state. Moreover, the combination of an in-use terminal unit and a non-use terminal unit from among the first terminal unit 2A and the second terminal unit 2B can be changed between the first state and the second state. Thus, the power path switching apparatus 1 can apply the common battery pack 100 when mounting it in the vehicle V suitable for the output path in the first state and when mounting it in the vehicle V suitable for the output path in the second state.

The terminal units 2 of the power path switching apparatus 1 include the first terminal unit 2A and the second terminal unit 2B. The first terminal unit 2A is a terminal disposed on one side of in a predetermined direction of the battery pack 100. The second terminal unit 2B is a terminal disposed on the other side in the predetermined direction of the battery pack 100 relative to the first terminal unit 2A. The switching unit 3 switches between the one-side output state in which the first terminal unit 2A serves as an in-use terminal unit and the second terminal unit 2B serves as a non-use terminal unit and the other-side output state in which the second terminal unit 2B serves as an in-use terminal unit and the first terminal unit 2A serves as a non-use terminal unit.

The first terminal unit 2A and the second terminal unit 2B of the power path switching apparatus 1 are disposed away from each other at different positions. Therefore, as a result of the switching unit 3 switching the state of the first terminal unit 2A and the second terminal unit 2B between the one-side output state and the other-side output state, it is possible to change the position at which power is output to the outside.

The switching unit 3 of the power path switching apparatus 1 switches between the one-side output state, the other-side output state, and the both-sides output state in which both the first terminal unit 2A and the second terminal unit 2B serve as in-use terminal units.

As a result of switching the state of the first terminal unit 2A and the second terminal unit 2B to the both-sides output state in addition to the one-side output state and the other-side output state, it is easy for the power path switching apparatus 1 to flexibly support the specifications of the vehicle V to which the battery pack is mounted.

The terminal units 2 of the power path switching apparatus 1 include the first terminal unit 2A and the second terminal unit 2B. The first terminal unit 2A is a terminal disposed on one side in a predetermined direction relative to the second terminal unit 2B in the vehicle V in which the battery pack 100 is mounted. The switching unit 3 switches between the either-side output state in which one of the first terminal unit 2A and the second terminal unit 2B serves as an in-use terminal unit and the other thereof serves as a non-use terminal unit, and the both-sides output state in which both the first terminal unit 2A and the second terminal unit 2B serve as in-use terminal units.

When a variation suitable for the either-side output state arises in the vehicle V suitable for the both-sides output state, it is easy for the power path switching apparatus 1 to flexibly support the specifications of the vehicle V.

In the both-sides output state, the switching unit 3 of the power path switching apparatus 1 configures a path for outputting power from a portion of the plurality of battery modules 10 via the first terminal unit 2A. The switching unit 3 configures a path for outputting power from another portion different from the portion of the plurality of battery modules 10, via the second terminal unit 2B.

In the power path switching apparatus 1, different battery modules 10 are connected to the first terminal unit 2A and the second terminal unit 2B, and thus it is easy to avoid a state where power cannot be output from both the first terminal unit 2A and the second terminal unit 2B.

When one of the first terminal unit 2A and the second terminal unit 2B serves as an in-use terminal unit and the other thereof serves as a non-use terminal unit, the switching unit 3 of the power path switching apparatus 1 connects at least a portion of the plurality of battery modules 10 in parallel. In the both-sides output state, the switching unit 3 connects the portion and the other portion in series.

The power path switching apparatus 1 connects the plurality of battery modules 10 in parallel or in series in accordance with the use state of the first terminal unit 2A and the second terminal unit 2B. Accordingly, the power path switching apparatus 1 can effectively use the plurality of battery modules 10, when power is output from one of the first terminal unit 2A and the second terminal unit 2B and when power is output from both the first terminal unit 2A and the second terminal unit 2B.

The predetermined direction Di of the power path switching apparatus 1 is the front-rear direction FR of the vehicle V.

When the loads L1 and L2 to be supplied with power are present respectively on the front side and the rear side of the vehicle V, the power path switching apparatus 1 connects the first terminal unit 2A or the second terminal unit 2B that is closer to each of the loads L1 and L2 and battery modules 10 in a connected state. Accordingly, the power path switching apparatus 1 can shorten the wiring that connects the loads L1 and L2 to the first terminal unit 2A and the second terminal unit 2B in the vehicle V.

### Second Embodiment

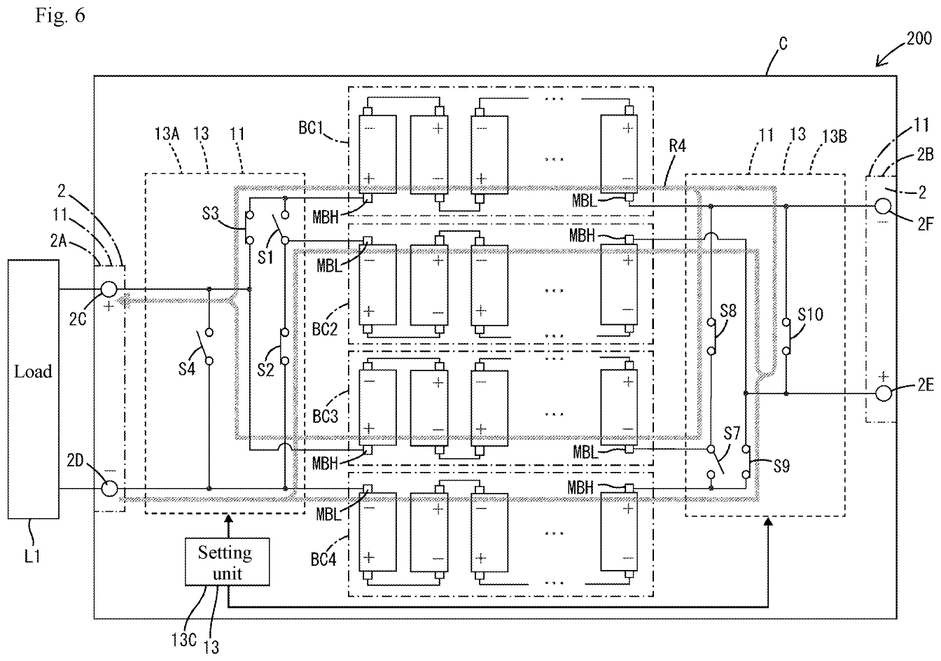

Next, a battery pack 200 in which a power path switching apparatus 11 according to a second embodiment is provided will be described with reference to FIGS. 6 to 8. The power path switching apparatus 11 is different from the power path switching apparatus in the first embodiment in that a first switching circuit 13A and a second switching circuit 13B do not include configurations corresponding to the fifth switch S5, the sixth switch S6, the eleventh switch S11, and the twelfth switch S12 in the first embodiment. The same reference numerals are given to the same configurations as those in the first embodiment, and a description of the structure, actions, and effects thereof is omitted.

As shown in FIG. 6, the first positive terminal 2C of the first terminal unit 2A is electrically connected to the highest-potential electrode MBH in the module row BC3. The first negative terminal 2D of the first terminal unit 2A is electrically connected to the lowest-potential electrode MBL in the module row BC4. The second positive terminal 2E of the second terminal unit 2B is connected to the highest-potential electrode MBH in the module row BC2. The second negative terminal 2F of the second terminal unit 2B is connected to the lowest-potential electrode MBL in the module row BC1.

### Operations of Battery Pack 200

A case will be described in which a switching unit 13 switches an output path of power to the first terminal unit 2A. In this case, a setting unit 13C switches and sets the states of the switches in the switching unit 13 as shown in FIG. 6. Specifically, the setting unit 13C sets the second switch S2 and the third switch S3 in the first switching circuit 13A to an on-state, and sets the first switch S1 and the fourth switch S4 to an off-state. In addition to this, the setting unit 13C sets the eighth switch S8, the ninth switch S9, and the tenth switch S10 in the second switching circuit 13B to an on-state, and sets the seventh switch S7 to an off-state. The load L1 provided close to the front of the vehicle V is electrically connected to the first positive terminal 2C and the first negative terminal 2D in the first terminal unit 2A. In this manner, the power path switching apparatus 11 realizes a configuration in which a current flows through the path indicated by the arrow R4. At this time, the first terminal unit 2A is an in-use terminal unit that is used as an output path of power, and the second terminal unit 2B is a non-use terminal unit that is not used as an output path of power. At this time, the state is the one-side output state in which the first terminal unit 2A serves as an in-use terminal unit and the second terminal unit 2B serves as a non-use terminal unit.

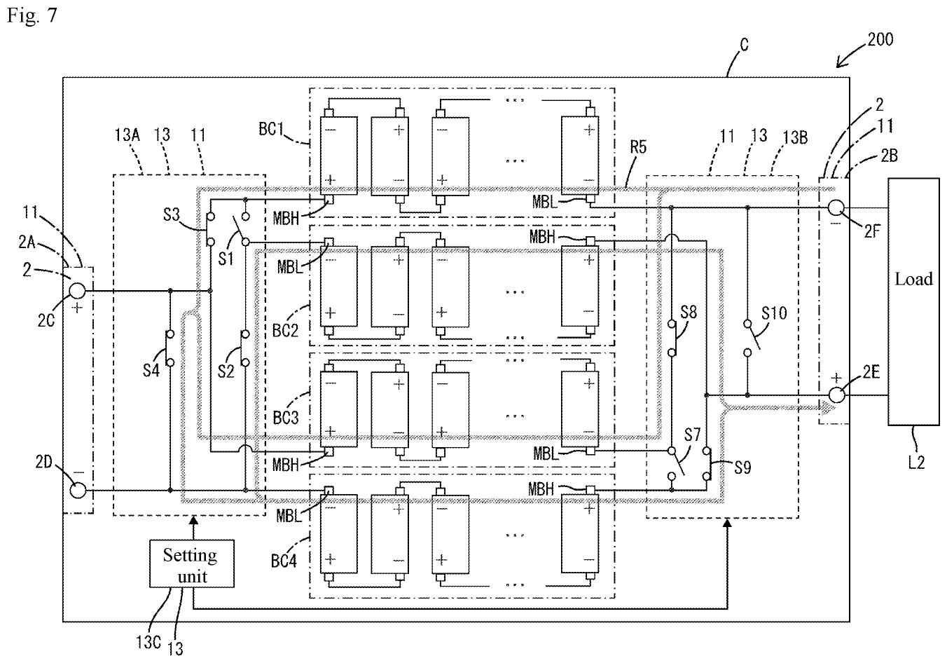

A case will be described in which the switching unit 13 switches an output path of power to the second terminal unit 2B. In this case, the setting unit 13C switches and sets the states of the switches in the switching unit 13 as shown in FIG. 7. Specifically, the setting unit 13C sets the second switch S2, the third switch S3, and the fourth switch S4 in the first switching circuit 13A to an on-state, and sets the first switch S1 to an off-state. In addition to this, the setting unit 13C sets the eighth switch S8 and the ninth switch S9 in the second switching circuit 13B to an on-state, and sets the seventh switch S7 and the tenth switch S10 to an off-state. The load L2 provided close to the rear of the vehicle V is electrically connected to the second positive terminal 2E and the second negative terminal 2F of the second terminal unit 2B. In this manner, the power path switching apparatus 11 realizes a configuration in which a current flows through the path indicated by the arrow R5. The switching unit 13 switches between a one-side output state in which the first terminal unit 2A serves as an in-use terminal unit and the second terminal unit 2B serves as a non-use terminal unit, and an other-side output state in which the second terminal unit 2B serves as an in-use terminal unit and the first terminal unit 2A serves as a non-use terminal unit. At this time, the state is the other-side output state in which the second terminal unit 2B serves as an in-use terminal unit and the first terminal unit 2A serves as a non-use terminal unit.

In this case, the one-side output state corresponds to a first state, and the other-side output state corresponds to a second state. In the one-side output state (first state), the first terminal unit 2A serves as an in-use terminal unit and the second terminal unit 2B (the other terminal unit) serves as a non-use terminal unit. In the other-side output state (second state), the second terminal unit 2B serves as an in-use terminal unit and the first terminal unit 2A (the other terminal unit) serves as a non-use terminal unit. Accordingly, the switching unit 13 changes the combination of an in-use terminal unit that is used as an output path of power and a non-use terminal unit that is not used as an output path of power between the one-side output state (first state) and the other-side output state (second state) among the terminal units 2.

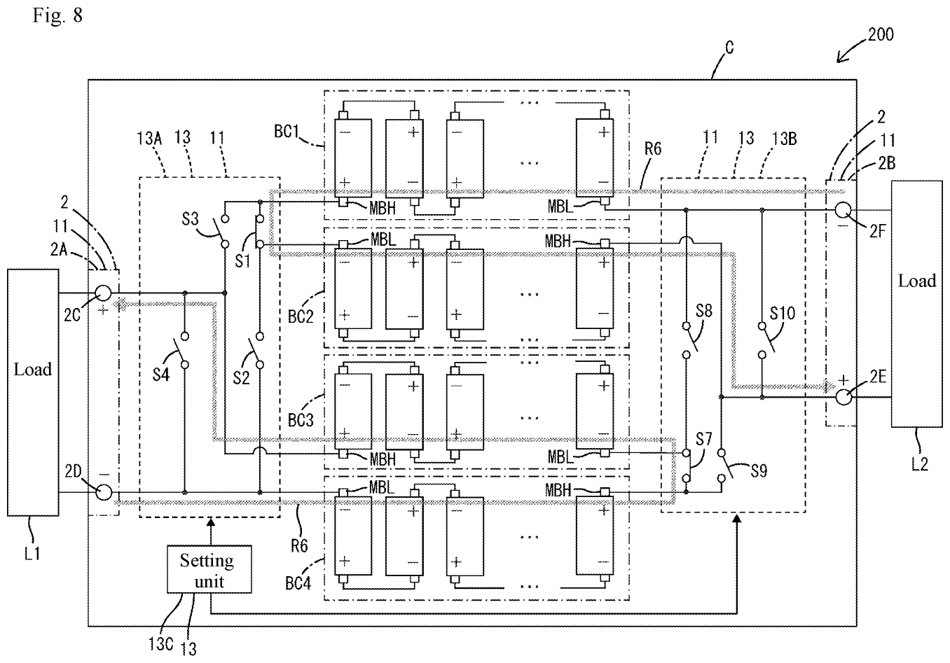

A case will be described in which the switching unit 13 switches to a both-sides output state in which both the first terminal unit 2A and the second terminal unit 2B serve as in-use terminal units. In this case, the setting unit 13C switches and sets the states of the switches in the switching unit 13 as shown in FIG. 8. Specifically, the setting unit 13C sets the first switch S1 in the first switching circuit 13A to an on-state, and sets the second switch S2, the third switch S3, and the fourth switch S4 to an off-state. In addition to this, the setting unit 13C sets the seventh switch S7 in the second switching circuit 13B to an on-state, and sets the eighth switch S8, the ninth switch S9, and the tenth switch S10 to an off-state. The load L1 provided close to the front of the vehicle V is electrically connected to the first positive terminal 2C and the first negative terminal 2D of the first terminal unit 2A. The load L2 provided close to the rear of the vehicle V is connected to the second positive terminal 2E and the second negative terminal 2F of the second terminal unit 2B. In this manner, the power path switching apparatus 11 realizes a configuration in which a current flows through the path indicated by the arrow R6. In the both-sides output state, the switching unit 13 configures a path for outputting power from a portion of the plurality of battery modules 10 via the first terminal unit 2A, and configures a path for outputting power from another portion different from the portion of the plurality of battery modules 10 via the second terminal unit 2B.

In this case, an either-side output state corresponds to a first state and the both-sides output state corresponds to a second state. In the either-side output state (first state), one of the first terminal unit 2A and the second terminal unit 2B serves as an in-use terminal unit and the other thereof serves as a non-use terminal unit. In the both-sides output state (second state), there is no terminal unit 2 corresponding to a non-use terminal unit. Accordingly, the switching unit 13 changes the combination of an in-use terminal unit that is used as an output path of power and a non-use terminal unit that is not used as an output path of power, among the terminal units 2, between the either-side output state (first state) and the both-sides output state (second state).

### Third Embodiment

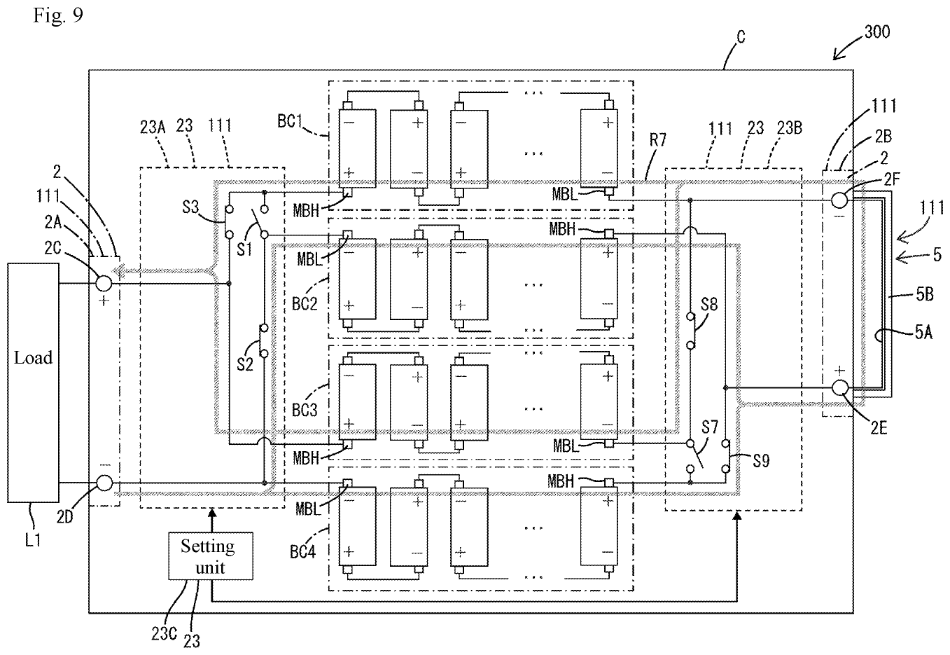

Next, a battery pack 300 in which a power path switching apparatus 111 according to a third embodiment is provided will be described with reference to FIGS. 9 to 11. The power path switching apparatus 111 is different from the power path switching apparatuses in the first and second embodiments in that a first switching circuit 23A and a second switching circuit 23B do not include configurations corresponding to the fourth switch S4, the fifth switch S5, the sixth switch S6, the tenth switch S10, the eleventh switch S11, and the twelfth switch S12 according to the first embodiment, a connector unit 5 is provided, and the like. The same reference numerals are given to the same configurations as those in the first and second embodiments, and a description of the structure, actions, and effects thereof is omitted.

As shown in FIG. 9, the first positive terminal 2C of the first terminal unit 2A is electrically connected to the highest-potential electrode MBH in the module row BC3. The first negative terminal 2D of the first terminal unit 2A is electrically connected to the lowest-potential electrode MBL in the module row BC4. The second positive terminal 2E of the second terminal unit 2B is electrically connected to the highest-potential electrode MBH in the module row BC2. The second negative terminal 2F of the second terminal unit 2B is electrically connected to the lowest-potential electrode MBL in the module row BC1.

The connector unit 5 is configured to be detachably mounted to one of the first terminal unit 2A and the second terminal unit 2B. Specifically, the connector unit 5 is attached to a non-use terminal unit. The connector unit 5 includes a connector unit body 5A and a cover portion 5B. The connector unit body 5A is made of metal, and establishes electrical continuity between the first positive terminal 2C and the first negative terminal 2D as a result of the connector unit 5 being attached to the first terminal unit 2A, and interrupts electrical continuity between the first positive terminal 2C and the first negative terminal 2D as a result of the connector unit 5 being detached from the first terminal unit 2A. The connector unit body 5A establishes electrical continuity between the second positive terminal 2E and the second negative terminal 2F as a result of the connector unit 5 being attached to the second terminal unit 2B, and interrupts electrical continuity between the second positive terminal 2E and the second negative terminal 2F as a result of the connector unit 5 being detached from the second terminal unit 2B. The connector unit 5 establishes electrical continuity between a plurality of terminals in a non-use terminal unit.

The cover portion 5B is formed of rubber, a synthetic resin, or the like, covers the first terminal unit 2A as a result of the connector unit 5 being attached to the first terminal unit 2A, and prevents water from infiltrating into the battery pack 300 from the first terminal unit 2A. The cover portion 5B covers the second terminal unit 2B as a result of the connector unit 5 being attached to the second terminal unit 2B, and prevents water from infiltrating into the battery pack 300 from the second terminal unit 2B. That is to say, the cover portion 5B covers a non-use terminal unit.

### Operations of Battery Pack 300

A case will be described in which a switching unit 23 switches an output path of power to the first terminal unit 2A. In this case, a setting unit 23C switches and sets the states of the switches in the switching unit 23 as shown in FIG. 9. Specifically, the setting unit 23C sets the second switch S2 and the third switch S3 of the first switching circuit 23A to an on-state, and sets the first switch S1 to an off-state. In addition to this, the setting unit 23C sets the eighth switch S8 and the ninth switch S9 in the second switching circuit 23B to an on-state, and sets the seventh switch S7 to an off-state. The load L1 provided close to the front of the vehicle V is electrically connected to the first positive terminal 2C and the first negative terminal 2D of the first terminal unit 2A. The connector unit 5 is attached to the second terminal unit 2B, and electrical continuity between the second positive terminal 2E and the second negative terminal 2F is established by the connector unit body 5A. In this manner, the power path switching apparatus 111 realizes a configuration in which a current flows through the path indicated by the arrow R7. At this time, the first terminal unit 2A is an in-use terminal unit that is used as an output path of power, and the second terminal unit 2B is a non-use terminal unit that is not used as an output path of power. At this time, the state is the one-side output state in which the first terminal unit 2A serves as an in-use terminal unit and the second terminal unit 2B serves as a non-use terminal unit.

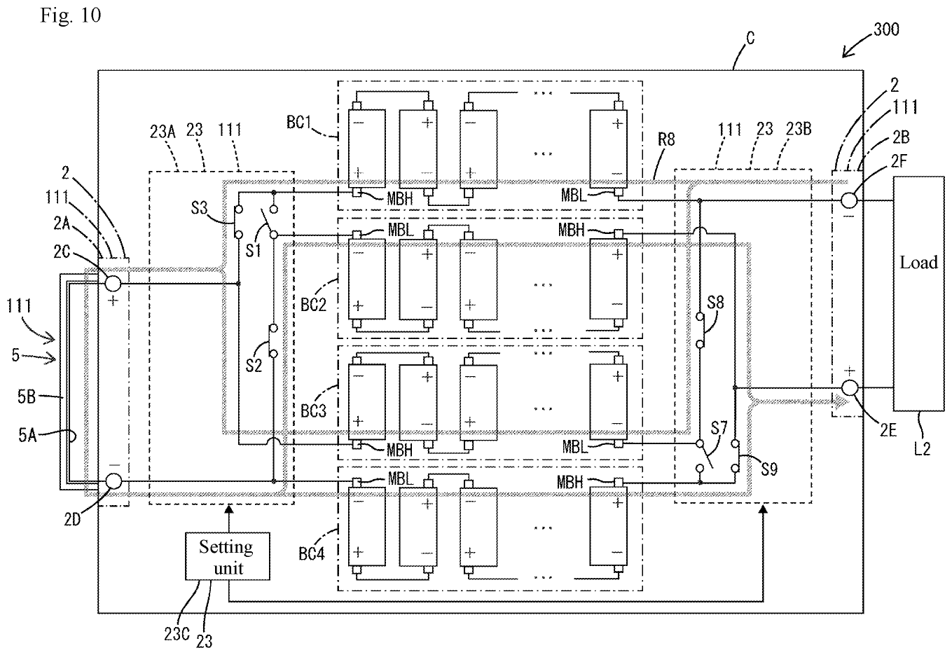

A case will be described in which the switching unit 23 switches an output path of power to the second terminal unit 2B. In this case, for example, the setting unit 23C switches and sets the states of the switches in the switching unit 3 as shown in FIG. 10. Specifically, the setting unit 23C sets the second switch S2 and the third switch S3 in the first switching circuit 23A to an on-state, and sets the first switch S1 to an off-state. In addition to this, the setting unit 23C sets the eighth switch S8 and the ninth switch S9 in the second switching circuit 23B to an on-state, and sets the seventh switch S7 to an off-state. The load L2 provided close to the rear of the vehicle V is electrically connected to the second positive terminal 2E and the second negative terminal 2F of the second terminal unit 2B. The connector unit 5 is attached to the first terminal unit 2A, and electrical continuity between the first positive terminal 2C and the first negative terminal 2D is established by the connector unit body 5A. In this manner, the power path switching apparatus 111 realizes a configuration in which a current flows through the path indicated by the arrow R8. The switching unit 23 switches between a one-side output state in which the first terminal unit 2A serves as an in-use terminal unit and the second terminal unit 2B serves as a non-use terminal unit and an other-side output state in which the second terminal unit 2B serves as an in-use terminal unit and the first terminal unit 2A serves as a non-use terminal unit. At this time, the state is the other-side output state in which the second terminal unit 2B serves as an in-use terminal unit and the first terminal unit 2A serves as a non-use terminal unit.

In this case, the one-side output state corresponds to a first state, and the other-side output state corresponds to a second state. In the one-side output state (first state), the first terminal unit 2A serves as an in-use terminal unit and the second terminal unit 2B (the other terminal unit) serves as a non-use terminal unit. In the other-side output state (second state), the second terminal unit 2B serves as an in-use terminal unit and the first terminal unit 2A (the other terminal unit) serves as a non-use terminal unit. That is to say, the switching unit 23 changes the combination of an in-use terminal unit that is used as an output path of power and a non-use terminal unit that is not used as an output path of power, among the terminal units 2, between the one-side output state (first state) and the other-side output state (second state).

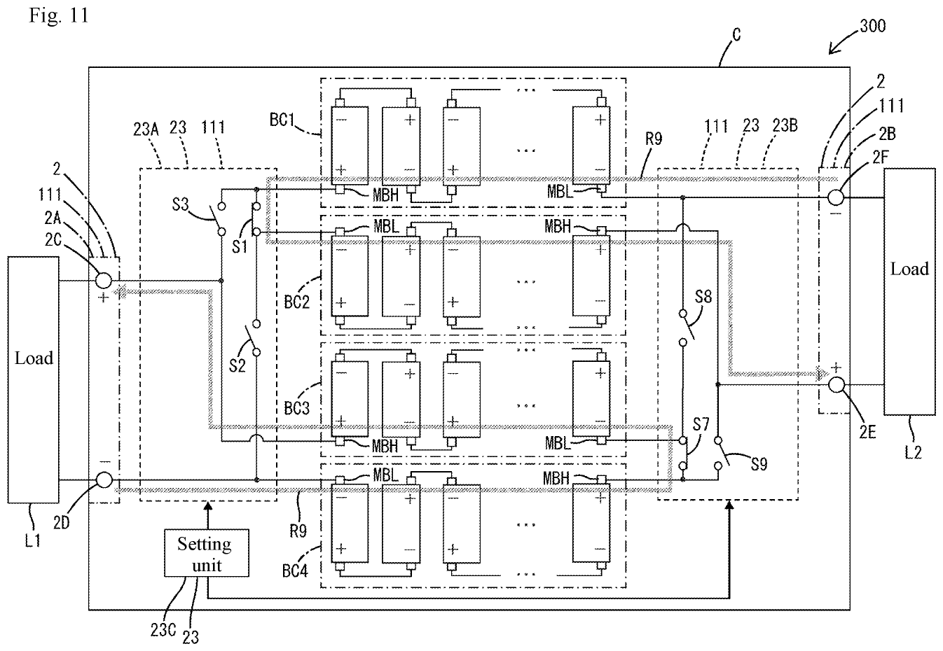

A case will be described in which the switching unit 23 switches to a both-sides output state in which both the first terminal unit 2A and the second terminal unit 2B serve as in-use terminal units. In this case, the setting unit 23C switches and sets the states of the switches in the switching unit 23 as shown in FIG. 11. Specifically, the setting unit 23C sets the first switch S1 in the first switching circuit 23A to an on-state, and sets the second switch S2 and the third switch S3 to an off-state. In addition to this, the setting unit 23C sets the seventh switch S7 in the second switching circuit 23B to an on-state, and sets the eighth switch S8 and the ninth switch S9 to an off-state. The load L1 provided close to the front of the vehicle V is connected to the first positive terminal 2C and the first negative terminal 2D of the first terminal unit 2A. The load L2 provided close to the rear of the vehicle V is connected to the second positive terminal 2E and the second negative terminal 2F of the second terminal unit 2B. In this manner, the power path switching apparatus 111 realizes a configuration in which a current flows through the path indicated by the arrow R9. In the both-sides output state, the switching unit 23 configures a path for outputting power from a portion of the plurality of the battery modules 10 via the first terminal unit 2A, and configures a path for outputting power from another portion different from the portion of the plurality of battery modules 10, via the second terminal unit 2B.

In this case, an either-side output state corresponds to a first state, and the both-sides output state corresponds to a second state. In the either-side output state (first state), one of the first terminal unit 2A and the second terminal unit 2B serves as an in-use terminal unit and the other thereof serves as a non-use terminal unit. In the both-sides output state (second state), there is no terminal unit 2 corresponding to a non-use terminal unit. That is to say, the switching unit 23 changes the combination of an in-use terminal unit that is used as an output path of power and a non-use terminal unit that is not used as an output path of power, among the terminal units 2, between the either-side output state (first state) and the both-sides output state (second state).

The power path switching apparatus 111 includes the connector unit 5 that is attachable/detachable to/from the terminal units 2, and the connector unit 5 is attached to a non-use terminal unit, and establishes continuity between a plurality of predetermined terminals in a non-use terminal unit while covering the non-use terminal unit.

The power path switching apparatus 111 can simplify the configuration of the switching unit 23.

### Other Embodiments

The present disclosure is not limited to the embodiments described above and described with reference to the drawings. Any combination of features of the above embodiments above and embodiments described below can be made as long as there is no contradiction, for example. Moreover, any features of the embodiments described above and below can also be omitted if not clearly described as essential. Moreover, the above embodiments can be changed as follows.

The first embodiment discloses that one unit battery constitutes one battery part. Units for constituting a battery part are not limited to this example. A plurality of unit batteries may constitute one battery part, for example.

In the first to third embodiments, a configuration that includes four module rows is illustrated. The number of module rows is not limited to four.

The first embodiment illustrates that the setting unit 3C is an information processing apparatus. There is no limitation to this, and the setting unit may also be a control apparatus that controls on/off of a plurality of switches, may also be an apparatus that determines on/off of a plurality of switches in accordance with an external operation, or may also be an apparatus that determines on/off of a plurality of switches based on setting information. In any case, it suffices for the setting unit to be an apparatus that can determine on/off of a plurality of switches using setting content that is based on the vehicle after the battery pack is mounted in the vehicle.

The first to third embodiments disclose two terminal units 2, namely the first terminal unit 2A and the second terminal unit 2B. However, the number of terminal units is not limited to this. That is to say, the terminal units may include at least a first terminal unit and a second terminal unit.

Note that the embodiments disclosed herein are to be considered as illustrative and non-limiting in all aspects. The scope of the present disclosure is not limited by the embodiments disclosed herein, and all changes that come within the range indicated by the claims or the range of equivalency of the claims are intended to be embraced therein.

### LIST OF REFERENCE NUMERALS

1, 11, 111 Power path switching apparatus

2 Terminal unit

2A First terminal unit

2B Second terminal unit

2C First positive terminal

2D First negative terminal

2E Second positive terminal

2F Second negative terminal

3, 13, 23 Switching unit

3A, 13A, 23A First switching circuit

3B, 13B, 23B Second switching circuit

3C, 13C, 23C Setting unit

5 Connector unit

5A Connector unit body

5B Cover portion

10 Battery module

100, 200, 300 Battery pack

BC1, BC2, BC3, BC4 Module row

BH High-potential side electrode

BL Low-potential side electrode

C Case

Di Predetermined direction

FR Front-rear direction

L1, L2 Load

MBH Highest-potential electrode

MBL Lowest-potential electrode

R1, R2, R3, R4, R5, R6, R7, R8, R9 Arrow

S1 First switch

S2 Second switch

S3 Third switch

S4 Fourth switch

S5 Fifth switch

S6 Sixth switch

S7 Seventh switch

S8 Eighth switch

S9 Ninth switch

S10 Tenth switch

S11 Eleventh switch

S12 Twelfth switch

V Vehicle

1-8. (canceled)

9. A power path switching apparatus for a vehicle comprising:
a plurality of terminal units configured to be provided in a battery pack that includes a plurality of battery modules; and
a switching unit configured to be provided in the battery pack, and to switch a path for supplying power from the battery modules,
wherein the plurality of terminal units are disposed away from each other at different positions in the battery pack,
the switching unit changes a combination of an in-use terminal unit that is used as an output path of the power and a non-use terminal unit that is not used as an output path of the power, among the plurality of terminal units, between a first state and a second state,
the plurality of terminal units include at least a first terminal unit and a second terminal unit,
the first terminal unit is a terminal disposed on one side in a predetermined direction of the battery pack,
the second terminal unit is a terminal disposed on the other side in the predetermined direction of the battery pack relative to the first terminal unit,
the switching unit switches between a one-side output state in which the first terminal unit serves as the in-use terminal unit and the second terminal unit serves as the non-use terminal unit and an other-side output state in which the second terminal unit serves as the in-use terminal unit and the first terminal unit serves as the non-use terminal unit,
in the one-side output state, power is supplied from the first terminal unit to a load of a vehicle, and
in the other-side output state, power is supplied from the second terminal unit to the load of the vehicle.

10. A power path switching apparatus for a vehicle comprising:
a plurality of terminal units configured to be provided in a battery pack that includes a plurality of battery modules; and
a switching unit configured to be provided in the battery pack, and to switch a path for supplying power from the battery modules,
wherein the plurality of terminal units are disposed away from each other at different positions in the battery pack,
the switching unit changes a combination of an in-use terminal unit that is used as an output path of the power and a non-use terminal unit that is not used as an output path of the power, among the plurality of terminal units, between a first state and a second state,
the plurality of terminal units include a first terminal unit and a second terminal unit,
the first terminal unit is a terminal disposed on one side in a predetermined direction relative to the second terminal unit, in a vehicle in which the battery pack is to be mounted,
the switching unit switches between an either-side output state in which one of the first terminal unit and the second terminal unit serves as the in-use terminal unit and the other thereof serves as the non-use terminal unit and a both-sides output state in which both the first terminal unit and the second terminal unit serve as the in-use terminal unit,
in the either-side output state, power is supplied from one of the first terminal unit and the second terminal unit to a load of the vehicle, and
in the both-sides output state, power is supplied from the first terminal unit and the second terminal unit to the load of the vehicle.

11. The power path switching apparatus for a vehicle according to claim 9,
wherein the switching unit switches between the one-side output state, the other-side output state, and a both-sides output state in which both the first terminal unit and the second terminal unit serve as the in-use terminal unit.

12. The power path switching apparatus for a vehicle according to claim 10,
wherein, in the both-sides output state, the switching unit configures a path for outputting power from a portion of the plurality of battery modules via the first terminal unit, and configures a path for outputting power from another portion different from the portion of the plurality of battery modules via the second terminal unit.

13. The power path switching apparatus for a vehicle according to claim 12,
wherein, when one of the first terminal unit and the second terminal unit serves as the in-use terminal unit and the other thereof serves as the non-use terminal unit, the switching unit switches at least a portion of the plurality of battery modules to a parallel connection state, and, in the both-sides output state, the switching unit switches the portion and the other portion individually to an in-series connection state.

14. The power path switching apparatus for a vehicle according to claim 9,
wherein the predetermined direction is a front-rear direction of the vehicle.

15. The power path switching apparatus for a vehicle according to claim 9, further comprising:
a connector unit configured to be attachable/detachable to/from the terminal units,
wherein the connector unit is attached to the non-use terminal unit, and establishes electrical continuity between a plurality of predetermined terminals in the non-use terminal unit while covering the non-use terminal unit.
